(19) United States
(12) Patent Application Publication
(10) Pub. No.: US 2016/0132820 A1
(43) Pub. Date: May 12, 2016

(54) ON-CALL SYSTEM AND METHOD

(71) Applicant: Barry Reese, Pittsburgh, PA (US)

(72) Inventor: Barry Reese, Pittsburgh, PA (US)

(21) Appl. No.: 14/468,331

(22) Filed: Aug. 26, 2014

(51) Int. Cl. G06Q 10/06; G06Q 10/10

(52) U.S. Cl. CPC G06Q 10/063116; G06Q 10/1093

(57) ABSTRACT

A scheduling apparatus comprises a server computer and a first set of instructions executable on the server computer configured to receive availability and unavailability data from one or more users. The first set of instructions are further executable to present a display to each of the one or more users of a calendar displaying a shift schedule for each of said users. The first set of instructions are further configured to receive a request from a first of the one or more users, and transmit to a second of the one or more users, a request to cover a shift from said shift schedule of said first user. The first set of instructions are further configured to receive a confirmation message from the second user to transmit to the first user reflecting that the second user will cover the first user's shift. The first set of instructions are further configured to change the display of the calendar of the first user to reflect that the second user will cover the first user's shift.

### FIELD OF THE INVENTION

The invention relates to on-call system and method. Specifically, the system and method provides a re-time system and method for scheduling of persons for on-call duties for an occupation or organization.

### SUMMARY OF THE INVENTION

In order to solve the problems and shortcomings of the prior art, a scheduling apparatus, comprises: a server computer; a first set of instructions executable on the server computer configured to receive availability and unavailability data from one or more users; the first set of instructions further executable to present a display to each of the one or more users of a calendar displaying a shift schedule for each of said users; the first set of instructions further configured to receive a request form a first of the one or more users, and transmit to a second of the one or more users, a request to cover a shift from said shift schedule of said first user; the first set of instructions further configured to receive a confirmation message from the second user to transmit to the first user reflecting that the second user will cover the first user's shift; and the first set of instructions further configured to change the display of the calendar of the first user to reflect that the second user will cover the first user's shift.

A scheduling method, comprising: receiving, on a server computer, availability and unavailability data from one or more users; displaying to each of the one or more users of a calendar displaying a shift schedule for each of said users; receiving a request form a first of the one or more users, and transmitting to a second of the one or more users, a request to cover a shift from said shift schedule of said first user; receiving a confirmation message from the second user to transmit to the first user reflecting that the second user will cover the first user's shift; and changing the display of the calendar of the first user to reflect that the second user will cover the first user's shift.

### BRIEF DESCRIPTION OF THE DRAWINGS

FIG. 1 is a diagrammatic overview of network platform that may be used in one embodiment of an on-call system and method;

FIG. 2 is a diagram illustrating selected components of the server of the embodiment of FIG. 1;

FIG. 3 is a diagram illustrating selected components of one or more of the devices according to the embodiment of FIG. 1;

FIG. 4A is a flow diagram describing steps executed by the software program and client application according to the embodiment of FIGS. 2 and 3;

FIG. 4B is a continuation of the flowchart of FIG. 4A;

FIG. 4C is a continuation of the flow chart of FIGS. 4A and 4B;

FIG. 4D is another continuation of the flow chart of FIG. 4A;

FIG. 5 is a series of two home screen shots that may be produced by the on-call client application;

FIG. 6 is a view of the home screen according to the embodiment of FIG. 5;

FIG. 7 is an exemplary my schedule screen according to one embodiment;

FIG. 8 is a diagram of an exemplary user menu according to one embodiment;

FIG. 9 is an exemplary make unavailable screen according to one embodiment;

FIG. 10 is an exemplary make unavailable screen according to one embodiment;

FIG. 11 is an exemplary on-call screen displaying ER on-call records retrieved from the database in the server;

FIG. 12 is an exemplary user detail screen that may be displayed after touching of the view-covering selection;

FIG. 13 is an exemplary directory screen according to one embodiment;

FIG. 14 is an exemplary today's schedule screen according to one embodiment;

FIG. 15 is the screen of FIG. 14 as shown after the user has tapped on top of one of the schedule bars to display detail in area;

FIG. 16 is a weekly schedule screen that may be provided by the client application allowing the user to view his or her weekly schedule at a glance;

FIG. 17 is a detailed call schedule screen according to one embodiment;

FIG. 18 is the call schedule screen of FIG. 17 with a selection box that may appear after the user touches a call schedule record;

FIG. 19 is an exemplary user listing screen that may be used for selection of another user to cover a shift according to one embodiment;

FIG. 20 is a typical phone or mobile device screen with an instant message displayed according to one embodiment;

FIG. 21 is a message screen according to one embodiment;

FIG. 22 is the message screen of FIG. 21 in a mode after the user has tapped one of the messages; and

FIG. 23 is a sample administrator screen that may be presented to a system administrator by the on-call software program that allows approval or disapproval of schedule changes.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

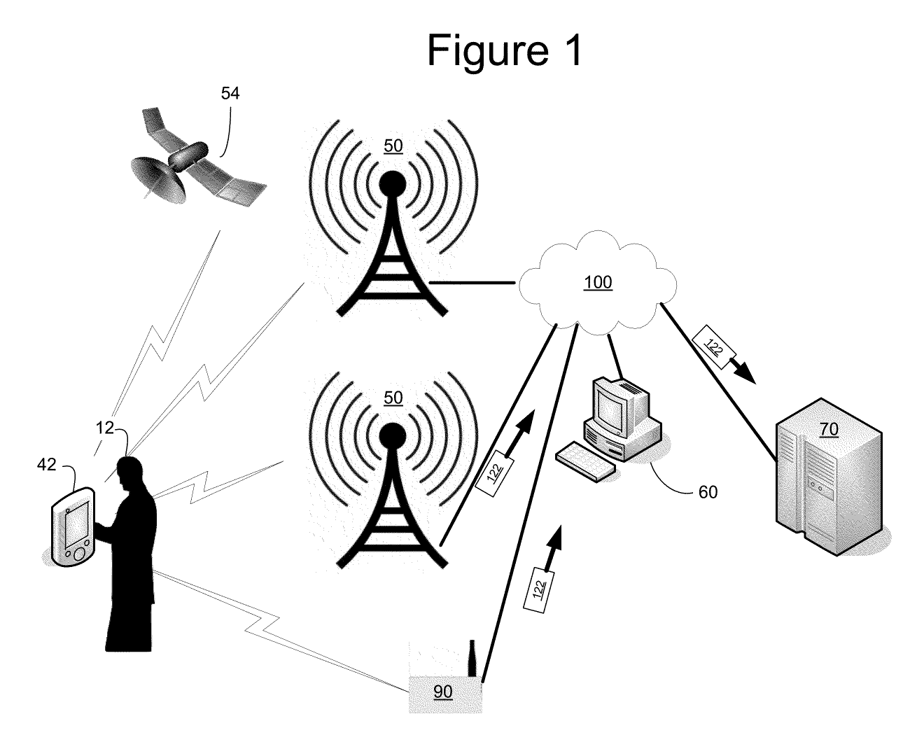

With reference to FIG. 1, a diagrammatic overview of network platform that may be used in one embodiment of an on-call system and method is shown. In one embodiment, a server computer 70 may comprise one or more complex instruction set computers (CISCs) or one or more reduced instruction set computers (RISCs). The server 70 may comprise a network connector that connects the server computer to a wide area network (WAN) 100. The WAN may comprise, for example, the Internet.

In one embodiment, the Internet 100 may thus provide for secure connections with the server computer 70 to electronic devices connected to the Internet 100. Said devices may include, by way of example and not by way of limitation, one or more personal mobile electronic devices 42 connected to Internet 100 via WiFi or a cellular network, which may comprise a digital 2G, 3G, 4G, WMAX, or other cellular network. In this regard, each personal mobile electronic device 42 may include, by way of example and not by way of limitation, a personal mobile communicator or cellular phone, smart phone, tablet, two-in-one, or any personal digital communicator.

The mobile devices 42 may communicate with the Internet 100 via cellular towers 50 located in the cellular network. In the case of a mobile device 42 that may comprise a satellite enabled device, such as a satellite phone, communication with the Internet 100 may occur via a satellite 54.

Further connected to the network may be one or more personal computing devices 60. Each personal computing device 60 may comprise, by way of example, a personal computer, a notebook computer, a tablet, a laptop computer, smart television (smart TV), Roku® device, or the like.

Any of the above-described devices may be WiFi enabled with a WiFi radio installed or integrated into the device as recognized by those of skill in the art. In this regard, a WiFi hub 90 may optionally be used with any of such WiFi-enabled devices to connected and communicate data 122 over the Internet 122.

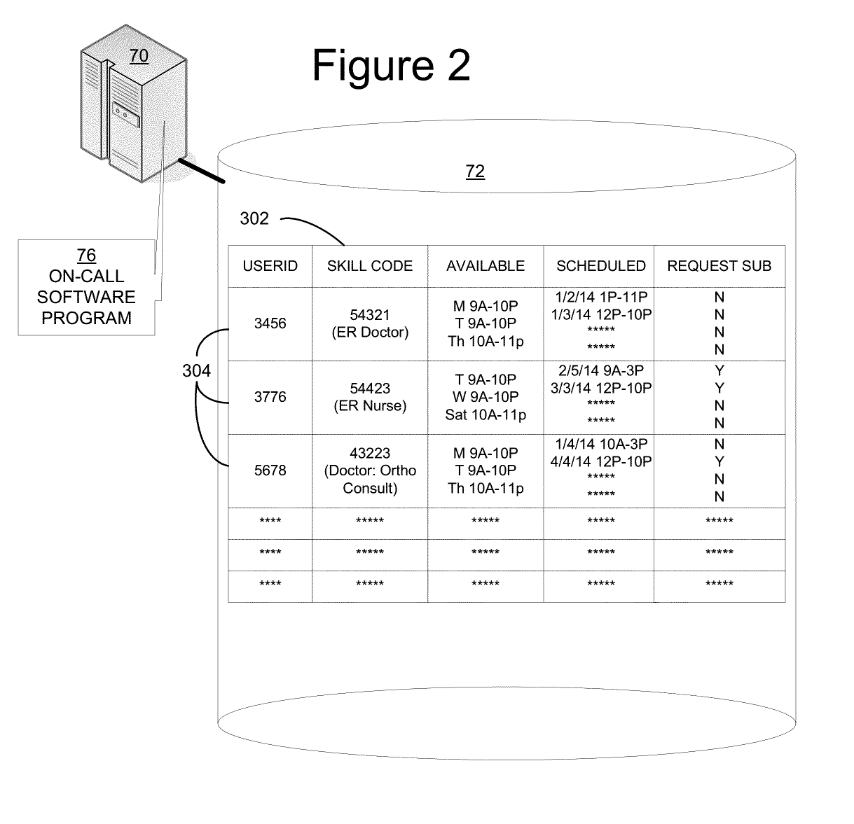

With reference to FIG. 2, a diagram illustrating selected components of the server 70 of the embodiment of FIG. 1 is shown. In one embodiment, the server 70 may comprise one or more sets of computer instructions, or software, that may comprise an on-call software program 76. Server 70 may further comprise one or more storage devices 72 for storing one or more databases 302. The database may include records 304 associated with available persons who are available to cover shifts, work times, work segments, time frames for club activities, volunteer organization shifts, and/or other time slots for other organizations. Further, in some embodiments, the database 302 may store records for non-live entitles, such as equipment available for lease, animals available for traveling petting zoos, and other conceivable things that may need to be scheduled, rescheduled, or substituted in terms of use in certain times or time slots.

It should be noted that in embodiments described herein, the system and method may be described in the context of heath care staffing, such as in a hospital setting in which doctors, nurses, and/or other staff needs to be scheduled. However, those of skill in the art would understand that the system and methods herein could be used in the context of scheduling the above other persons, entities, and things for shifts or use, and other similar persons, animals, or items.

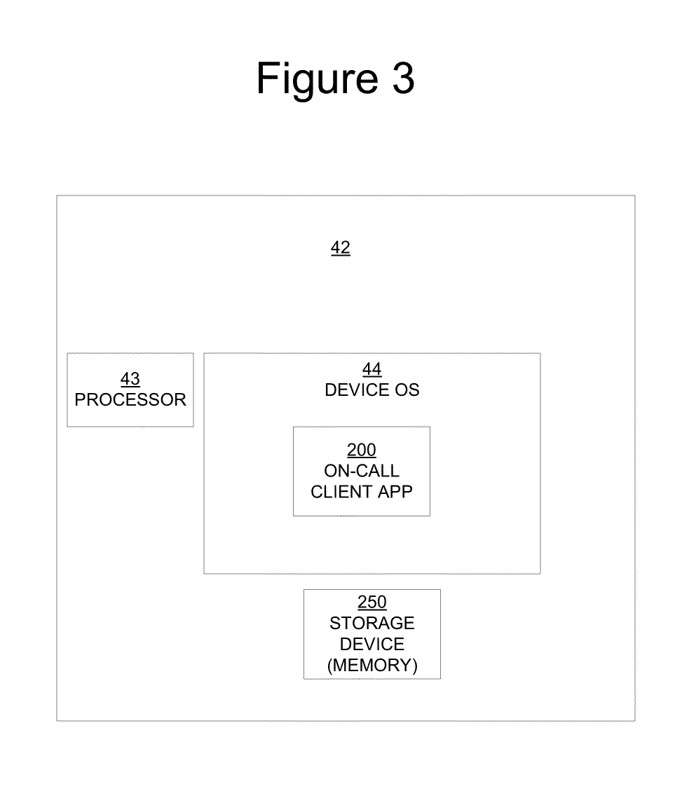

In the embodiment of FIG. 2, database records 304 for staffing shifts of a heath care organization such as a hospital are shown, by way of example and not by way of limitation. Further, the kind, types, and order of the fields in the database may vary from embodiment to embodiment as those of skill in the art would further recognize. In the exemplary embodiment of FIG. 3, some of the fields of the database records 304 may include, by way of example and not by way of limitation, a user identification or employee number (USERID), a job or skill code to identify the user's job (SKILL CODE), time shifts available for the person represented by the record 304 (AVAILABLE), time shifts for which the person is scheduled already (SCHEDULED), and toggle field for whether the person has submitted a request for another qualified person to cover a particular shift for which he or she has been scheduled (REQUEST SUB). The use of these and other fields will be described in relation to the operation and use of the on-call software program 76.

With reference to FIG. 3, selected components of one or more of the devices 42, 60 are shown according to the embodiment of FIG. 1. In one embodiment, devices 42 and 60 may have differing operation systems, and other hardware components, the devices 42 and 60 typically have certain common features. While some form of the components of FIG. 3 typically may exist in all the different devices 42 and 60 of FIG. 1, the universal components will be described with respect to devices 42 in FIG. 3, with those skilled in the art recognizing that these components may be in common with all devices 42 and 60 referenced and described above with respect to FIG. 1. By way of example, and not by way of limitation, device 42 may include a processor 44, and an operating system configured to execute on the processor. A memory storage device 250 may further be included to store both application code for applications, and application data. One of those applications may comprise a client portion of the on-call application 200 that executes on devices 42 and 60. Of course, the operation, look and feel of the on-call client application 200 may or may not have different configuration depending on whether the device 42 is a smart phone, tablet, or computer 60, or other type of device. For example, smart phone screens are typically smaller and may only display a certain amount of data on the screen at one time, whereas a computer 60 may be able to display more data at the same time.

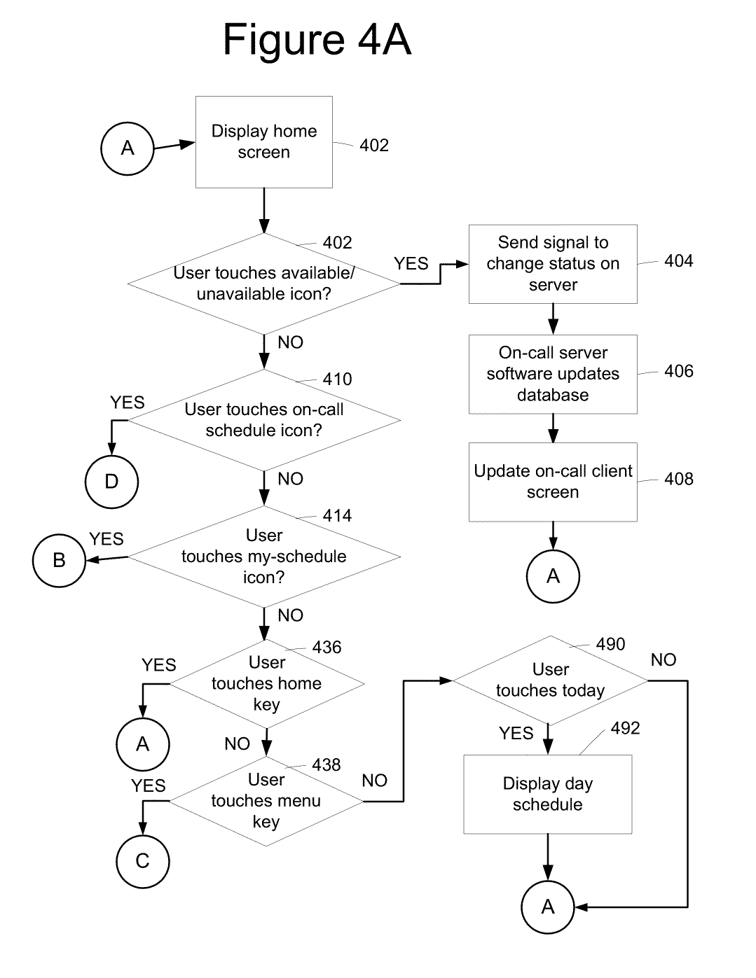

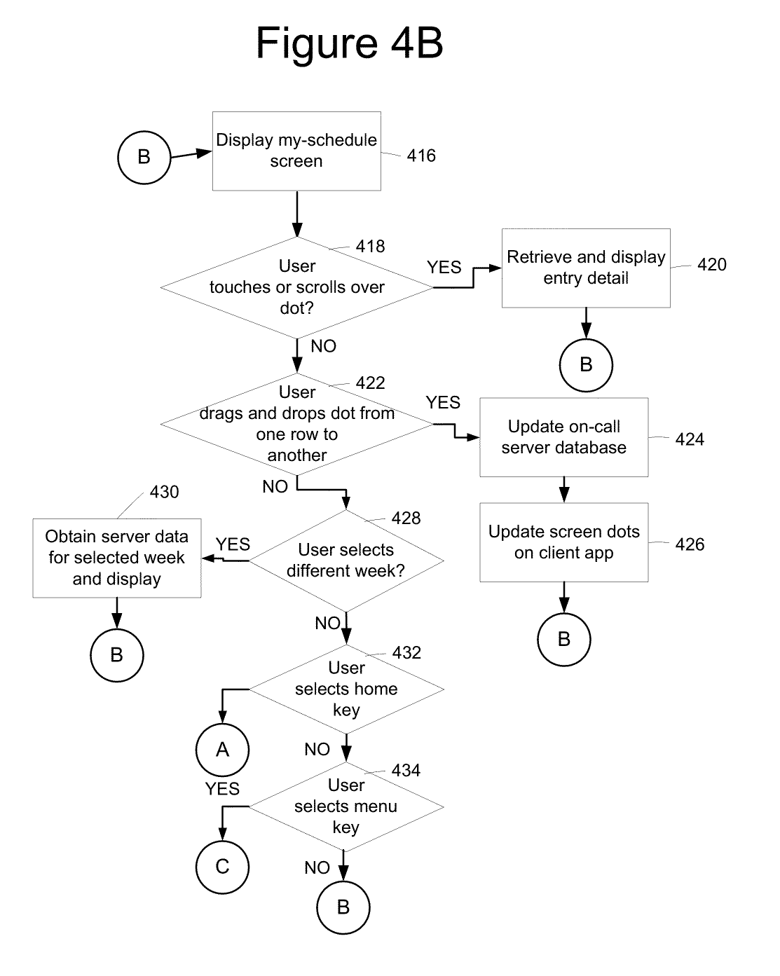

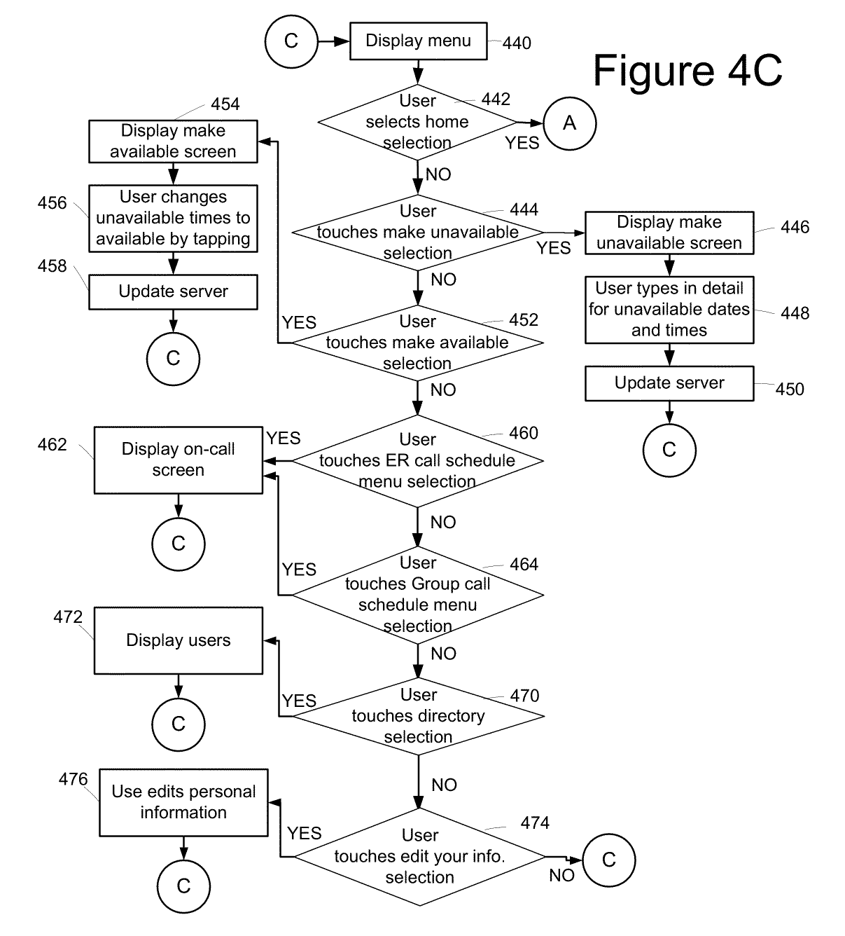

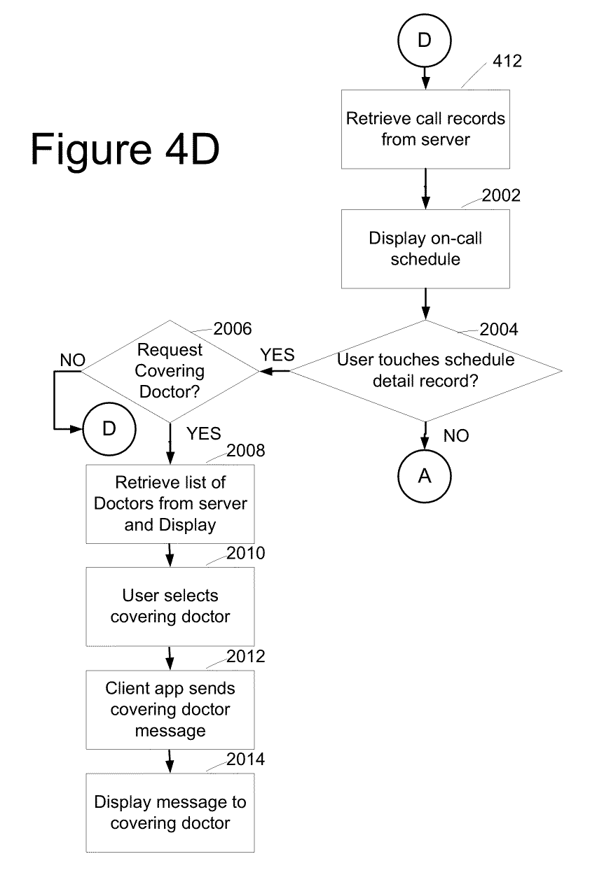

With reference to FIG. 4A, a flow diagram describing steps executed by the software program 76 and client application 200 according to the embodiment of FIGS. 2 and 3 is shown. It should be recognized by those of skill in the art that some steps may be performed by the client application 200 locally, and the server application 76, depending on sharing of resources, communication bandwidth, and other factors for application efficiency. The steps will be described with this understanding.

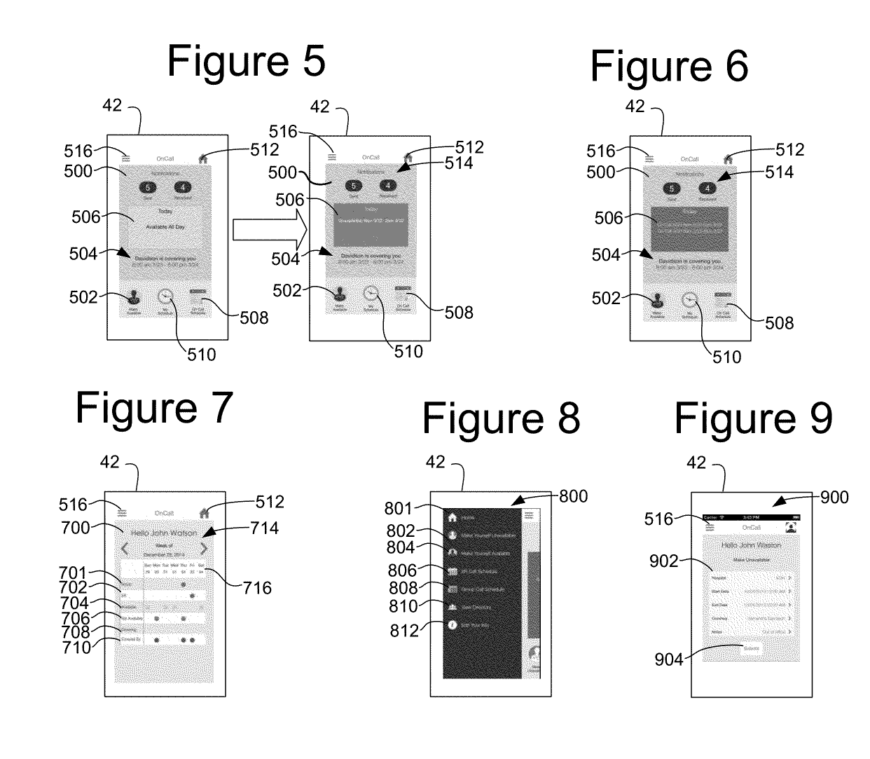

Also referencing FIG. 5 at the same time as FIG. 4A, a series of two home screen shots that may be produced by the on-call client application 200 is shown. Referring to FIG. 4A, in step 402, the user (12 in FIG. 1) may have set his or her on-call client app 200 to display a screen of his current status 500 as his or her home screen for the application. For example, the user 12 may have set his or her status to Available as reflected in a home screen 500 in FIG. 5. In screen 500, other important scheduling information may be displayed, for example, an area 504 of screen 500 may provide information regarding coverage for the user's shift that has been set in the system. Yet another area 506 of the home screen 500 may provide availability information for the user indicating whether the user is available currently to cover a shift.

In one embodiment, home screen 500 of FIG. 5 contains an available/unavailable (toggle) icon 502. In step 402 in FIG. 4A, the user may touch the available/unavailable icon 502 to change his status. In step 404, the on-call client app 200 may then provide a signal over network 100 to the server 70 on-call software 76 executing on the server 70 to change the status for the user in database 302 in storage device 72 to reflect the change of the user to unavailable, step 406. In step 408, once this change is made at the serer 70, the client on-call app 200 may then change the display area 506 to state that the user has made his status unavailable. Further in step 408, the available/unavailable icon 502 changes to from displaying the text available to unavailable. In one embodiment, in step 408, the area 506 may change color when the user has designated him or herself as unavailable, by way of example, and not by way of limitation, from yellow to orange. It should be noted, that in steps 402-408, had the user's status started out as unavailable, then the result would be the opposite, meaning that the home screen 500 would indicate available status at the end of step 408.

In step 410, if the user taps an on-call schedule button 508, then processing may move to FIG. 4D, which is another continuation of the flow chart of FIG. 4A. The user's on-call schedule may be displayed in display area 506 in step 412. With reference to FIG. 6, a view of the home screen 500 of FIG. 5 is shown, but with a sample of a user's on-call schedule displayed by the client app 200 in area 506. In one embodiment, when the on-call schedule is displayed in area 506, the area 506 may display the schedule in a different color than the available/unavailable information displayed in FIG. 5. For example, in FIG. 6, area 506 may have a green shade to display the on-call schedule information.

However, with reference to FIG. 17, in one embodiment, a more detailed call schedule screen 1700 may be displayed in step 2002. In one embodiment the on-call records may be displayed in detailed listings 1702 as shown in FIG. 17. In step 2004, if the user touches a detail record, then the user is given the option to request that another user cover his or her shift, step 2006. With reference to FIG. 18, the call schedule screen 1700 of FIG. 17 is shown with a selection box 1704 that may appear after the user touches a call schedule record 1702. If the user does want to request another user to cover a shift, then in step 2008, the client app 200 may request a download of available users to cover the shift for display.

With reference to FIG. 19, an exemplary user listing screen 1900 that may be used for selection of another user to cover a shift is shown. In step 2010, the user may select one of the user listings 1902 in the displayed list, the result of which is that the selected user may be sent a message requesting the shift change in step 2012.

With reference to FIG. 20, a typical phone or mobile device screen 2080 is shown, but with an instant message 2082 displayed, step 2014 in FIG. 4D as a result of the client app 200 sending a request for a shift change to the covering user.

With reference to FIG. 21, a message screen 2100 is shown according to one embodiment. The message screen 2100 may display sent and received requests and other system and user messages 2102.

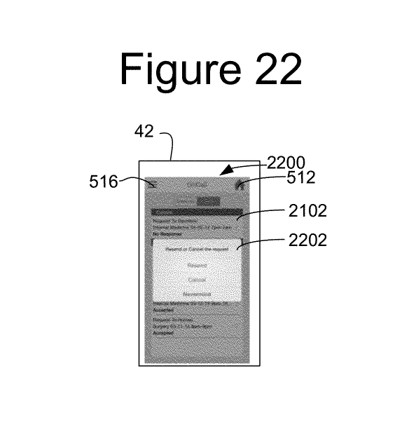

With reference to FIG. 22, the message screen of FIG. 21 is shown in a mode after the user has tapped one of the messages 2102. For example, if the user taps a request sent to another user, then the decision box 2202 may appear that allows the user to resend or cancel the request for coverage of a shift.

In step 414, if the user touches my schedule icon 510 on screen 500, then processing moves to FIG. 4B. With reference to FIG. 4B, a continuation of the flowchart of FIG. 4A is shown. In step 416, the client app 200 may display my schedule screen. With reference to FIG. 7, an exemplary my schedule screen 700 is shown according to one embodiment. In one embodiment, the my schedule screen 700 may contain a weekly grid. The weekly grid may comprise, for example, a wek setting selection area 714, a day of the week column indicator row 716, a group row 701 to indicate scheduled group shifts, an ER row 702 to indicate emergency room shifts, an availability row 704 to indicate available days, a not available row 706 to indicate days that the user is not available for shifts, a covering row 708 to indicate shifts that the user is covering for another user, and a covered by row 70 to indicate days in which the user's shifts are covered by another user. Colored dots may be used to indicate entries in each column and row.

In one embodiment, the color of the dots may aid in visualizing a user's schedule. For example, entries for scheduled shifts in rows 701 and 702 may comprise green colored dots, entries in row 704 to indicate availability for shifts may comprise yellow dots, entries in row 706 to indicate non-availability may comprise red colored dots, and entries in row 708 may again be green to indicate shifts that the user is scheduled to cover for other users, and entries in row 710 for the user's shifts covered by another user by comprise blue dots.

Further, again referencing again FIG. 4B concurrently with FIG. 7, in step 418 each of the colored dots may be selected by touch by the user or over-scrolling to display detailed information for the shift or unavailable time, which may include, for example, the start and end time for the shift, name of the user that is covering the shift if in row 708, and the name of the user for which the user is covering if in row 710. In step 420, the client app 200 retrieves the detailed information for the selected dot from the server 70, which retrieves the information from database 302, and sends the information securely to the client app 200 for display on the screen 700.

In step 422, if the user drags and drops a dot from one row to another, it may indicate that the user wishes to change his or her status for the time fame indicated by the dot. For example, in step 422, the user may select one of the red not available dots from the not available row 706 and drag it to the available row 704. In step 424, the client app 200 may send an update message to the server 70 over the network 100 to update the change. If the update is successful, then in step 426, the client app 200 may receive a message from the server to update the my schedule screen 700, turning the moved dot to the right color (in this example, yellow) and displaying it in the right position in the row.

Referring back to FIG. 7, the week selection area 714 may be selectable and/or contain arrows to change the display week on screen 700. Those of skill in the art would recognize that a calendar may appear on screen 700 to provide navigation to any week of any month and year through standard calendar navigation interfaces that may be integrated with the client app 200. Further, the user may be allowed to selected navigation arrows present on the side of the week selection area 714 to scroll back and forth through different weeks. In this regard, with reference back to FIG. 4B, in step 428, if the user selects a different week to display on screen 700, then in step 430, the client software may send a request to server 70 to retrieve the information to display on screen 700 for display, and display such information when received from server 70.

In step 436, if the user selects the home key (512 in FIGS. 5, 6 and 7), then home screen 500 in FIG. 5 is displayed, and processing moves to step 402 in FIG. 4A.

With reference to FIG. 4C, a continuation of the flow chart of FIGS. 4A and 4B is shown. If the user presses the menu key 516 in any of FIG. 5, 6 or 7 (step 434 in FIG. 4B or step 438 in FIG. 4A), then processing moves to step 440 in FIG. 4C, wherein the client app 200 displays a user menu. With reference to FIG. 8, a diagram of an exemplary user menu 800 is shown. In one embodiment, the displayed menu may have selections for home screen 801, make yourself unavailable 802, make yourself available 804, ER call schedule, view directory 810, and edit your info 812.

In step 442, if the user touches the home selection 801 from the menu 800, then processing moves to step 402 in FIG. 4A, wherein the client app 200 displays the home screen 500. In step 444 of FIG. 4C, if the user touches the make yourself unavailable menu selection 802, then in step 446, the client software displays a make unavailable screen.

With reference to FIG. 9, an exemplary make unavailable screen 900 is shown according to one embodiment. An edit area 902 of screen 900 allows the user to type in detailed date, time location, and coverage information for the time that the user is unavailable, step 448 of FIG. 4C. After receiving the entered information, the client app 200 may verify the information, and in step 450, forward the entered data to the server 70 for updating the database 302.

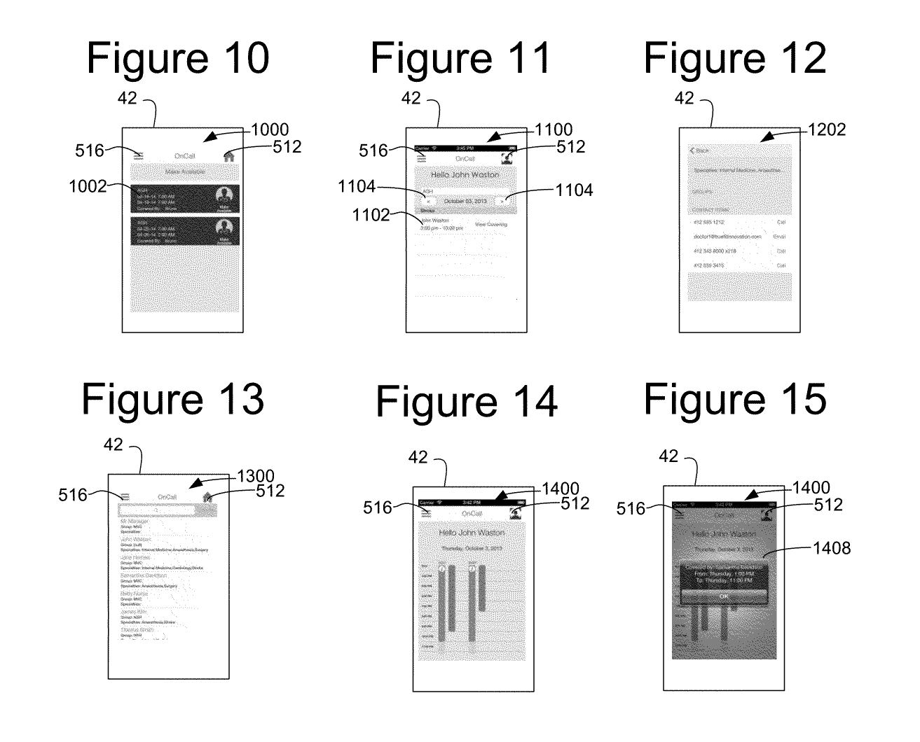

With reference to FIG. 10, an exemplary make unavailable screen 1000 is shown according to one embodiment. Listings 1002 indicating times during which the user has made him or herself unavailable are shown on screen 1000. With reference back to FIG. 4C, in step 454 the client app 200 displays screen 1000 with listings 1002. In step 456, the user may touch or tap the listings 1002 for which the user wishes to make him or herself available. After receiving the changes, the client app 200 may, in step 458, forward the changed data to the server 70 for updating the database 302.

With reference back to FIGS. 8 and 4C, in step 460, if the user touches the ER call schedule menu selection 806, then, in step 462, the on-call screen may be displayed for ER shifts scheduled for the user. With reference to FIG. 11, an exemplary on-call screen 1100 displaying the ER on-call records 1102 retrieved from the database 302 in the server 70 is shown. The user may touch day scroll buttons 1112 to retrieve different days from the server 70 and display the relevant records 1102 for the selected day on screen 1100.

In one embodiment, if one of the records 1102 is displayed with a view-covering selection 1106, then that may mean that there is another user covering the user's shift. The user may touch the view-covering selection 1106, in which case detail of the covering doctor may be retrieved from the database 302 in server 70 to display. With reference to FIG. 12, an exemplary user detail screen 1202 that may be displayed after touching of the view-covering selection 1106.

With reference back to FIGS. 8 and 4C, in step 464, if the user touches a group call schedule selection 808 on menu 800, then the group call records for the user are retrieved from the database 302 of the server 70. A screen 1102 may be displayed such as that of FIG. 11 to display the user's group call records.

With reference back to FIGS. 8 and 4C, in step 470, if the user touches a view directory selection 810 on menu 800, then the user records are retrieved from the database 302 of the server 70 and displayed on a directory screen. With reference to FIG. 13, an exemplary directory screen 1300 that may be displayed is shown.

With reference to back to FIGS. 8 and 4C, if the user touches the edit your info. menu selection 812 in step 474, the in step 476, the user may be presented with a screen to edit the user's personal and contact information.

With reference back to FIG. 4A and FIG. 6, in step 490, if the user taps the today area 506 on the screen 500, then, in step 492, client application 200 may display a today's schedule screen. With reference to FIG. 14, an exemplary today's schedule screen 1400 is shown. Screen 1400 may comprise a typical day calendar screen, but with bars indicating available, unavailable, and scheduled shift times. For example, a scheduled shift time may be shown as a green color bar spanning from the start time on the day calendar to the end time of the shift. Similarly, times that are available for the user for both ER shifts and group shifts may be shown in yellow, and times that the user has marked as unavailable may be show in red. In one embodiment, the user may tap on any of these bars to view further detail for each indicator bar. With reference to FIG. 15, screen 1400 is shown after the user has tapped on top of one of the schedule bars to display detail in area 1408.

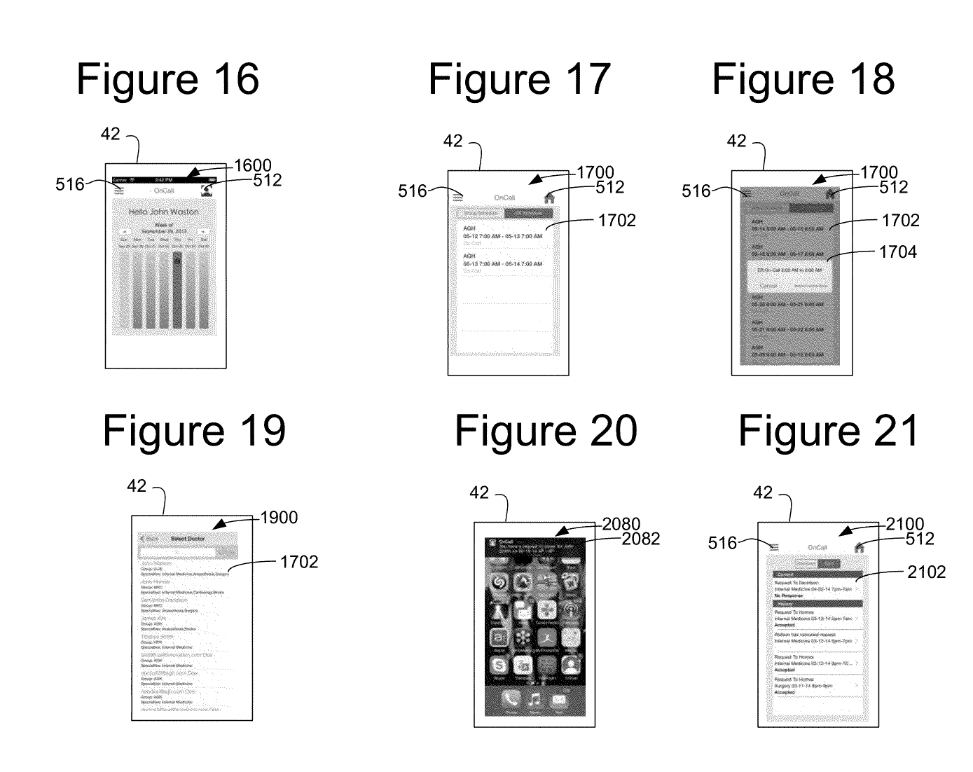

Other screens may be provided by the client application 200 for the convenience of the user. For example, with reference to FIG. 16, a weekly schedule screen may be provided by the client application 200 allowing the user to view his or her weekly schedule at a glance. In one embodiment, just as with the day schedule screen 1400 of FIG. 14, green, yellow, and red bars may similarly indicate scheduled shifts, available times, and unavailable times as in the day schedule screen. However, in one embodiment, for days that have times of verily availability and unavailability, for example, may fade in color accordingly to indicate that those days have days of mixed available and unavailable times.

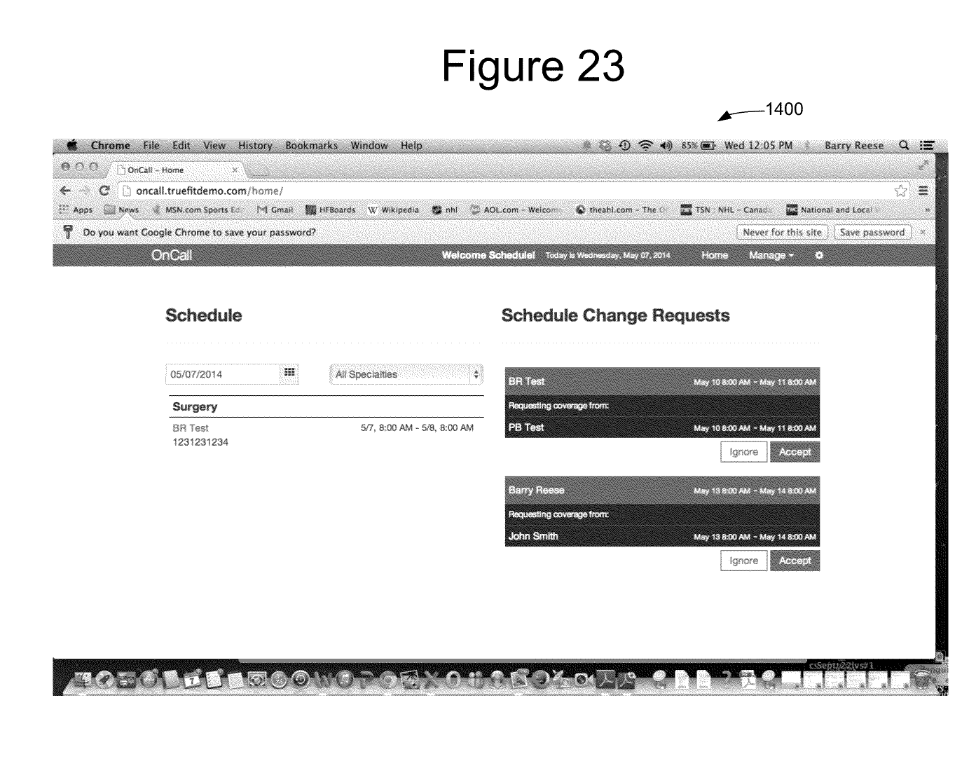

In one embodiment, all shift changes may be subject to approval by an administrator. With reference to FIG. 23, a sample administrator screen that may be presented to a system administrator by the on-call software program 76 (FIG. 2) that allows approval or disapproval of schedule changes is shown.

The various embodiments described above are provided by way of illustration only, and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A scheduling apparatus, comprising:
a server computer;
a first set of instructions executable on the server computer configured to receive availability and unavailability data from one or more users;
the first set of instructions further executable to present a display to each of the one or more users of a calendar displaying a shift schedule for each of said users;
the first set of instructions further configured to receive a request from a first of the one or more users, and transmit to a second of the one or more users, a request to cover a shift from said shift schedule of said first user;
the first set of instructions further configured to receive a confirmation message from the second user to transmit to the first user reflecting that the second user will cover the first user's shift; and
the first set of instructions further configured to change the display of the calendar of the first user to reflect that the second user will cover the first user's shift.

2. The scheduling apparatus of claim 1, further comprising a second set of executable instructions configured to execute on one or more electronic devices; the second set of executable instructions configured to display said calendar on a display of each electronic device.

3. The scheduling apparatus of claim 2, wherein the calendar comprises a weekly display comprising one or more colored bars reflecting scheduled shifts, available shift times, and unavailable shift times, wherein a first color represents a scheduled shift, a second color represents an available shift time, and a third color represents an unavailable shift time.

4. The scheduling apparatus of claim 3, wherein the second set of instructions is configured to present to the first user a process for said request from the first user to the second user to cover the first user's shift upon selection of a bar of the first color.

5. The scheduling apparatus of claim 4, wherein the process for said request includes presenting a selection list of said users who's calendar indicates that they have available shifts for the request.

6. The scheduling apparatus of claim 5, wherein the process for said request includes changing a bar on the second user's calendar from the second color to the first color based on the second user's acceptance of the first user's request.

7. The scheduling apparatus of claim 6, wherein the second set of instructions is for providing a daily-indicator on a home screen for whether the user has a shift, is available, or is unavailable, for the current day.

8. The scheduling apparatus of claim 7, wherein the daily-indicator is present in the first, second or third color depending whether the user has a shift, is available, or is unavailable for the current day.

9. The scheduling apparatus of claim 2, wherein the calendar comprises a monthly display comprising one or more colored dots reflecting scheduled shifts, available shift times, and unavailable shift times, wherein a first color represents a scheduled shift, a second color represents an available shift time, and a third color represents an unavailable shift time.

10. The scheduling apparatus of claim 9, wherein the second set of instructions is configured to present to the first user a process for said request from the first user to the second user to cover the first user's shift upon selection of a bar of the first color.

11. The scheduling apparatus of claim 10, wherein the process for said request includes presenting a selection list of said users who's calendar indicates that they have available shifts for the request.

12. The scheduling apparatus of claim 11, wherein the process for said request includes changing a dot on the second user's calendar from the second color to the first color based on the second user's acceptance of the first user's request.

13. The scheduling apparatus of claim 12, wherein the second set of instructions is for providing a daily-indicator on a home screen for whether the user has a shift, is available, or is unavailable, for the current day.

14. The scheduling apparatus of claim 14, wherein the daily-indicator is present in the first, second or third color depending whether the user has a shift, is available, or is unavailable for the current day.

15. The scheduling apparatus of claim 1, where the first set of instructions is capable of allowing the first user to fill out their contact information and designating who has access to this specific information, and further allowing changes said contact information, wherein said changes may be transferred in real time to anybody that has the access the apparatus.

16. A scheduling method, comprising:
receiving, on a server computer, availability and unavailability data from one or more users;
displaying to each of the one or more users of a calendar displaying a shift schedule for each of said users;
receiving a request form a first of the one or more users, and transmitting to a second of the one or more users, a request to cover a shift from said shift schedule of said first user;
receiving a confirmation message from the second user to transmit to the first user reflecting that the second user will cover the first user's shift; and
changing the display of the calendar of the first user to reflect that the second user will cover the first user's shift.

17. The method of claim 16, comprising displaying said calendar on a display of each of a plurality of electronic devices.

18. The method of claim 17, wherein the calendar comprises a weekly display comprising one or more colored bars reflecting scheduled shifts, available shift times, and unavailable shift times, wherein a first color represents a scheduled shift, a second color represents an available shift time, and a third color represents an unavailable shift time.

19. The method of claim 18, comprising presenting to the first user a process for said request from the first user to the second user to cover the first user's shift upon selection of a bar of the first color.

20. The method of claim 19, wherein the process for said request includes presenting a selection list of said users who's calendar indicates that they have available shifts for the request.
